(19) United States
(12) Patent Application Publication
(10) Pub. No.: US 2021/0014607 A1
(43) Pub. Date: Jan. 14, 2021

(54) WEARABLE AUDIO USER INTERFACE APPARATUS, METHOD, AND ARTICLE OF MANUFACTURE

(71) Applicants: Lee Cohen, Torrance, CA (US); Ross Snyder, Austin, TX (US)

(72) Inventors: Lee Cohen, Torrance, CA (US); Ross Snyder, Austin, TX (US)

(21) Appl. No.: 16/864,093

(22) Filed: Apr. 30, 2020

Related U.S. Application Data
(60) Provisional application No. 62/840,727, filed on Apr. 30, 2019.

(51) Int. Cl. H04R 1/46; H04R 1/10; G10L 25/78; A42B 1/04; A41D 1/00

(52) U.S. Cl. CPC H04R 1/46; H04R 1/10; H04R 2201/023; A42B 1/04; A41D 1/002; G10L 25/78

(57) ABSTRACT

A method, apparatus, and article of manufacture for a wearable audio user interface are described. In accordance with at least one embodiment, the apparatus or article of manufacture comprises a head covering configured to cover an upper portion of a user's head, a transmit audio transducer located in a forehead region of the head covering, and a receive audio transducer located in a temporal region of the head covering. The transmit audio transducer is configured to provide directional response oriented toward a user's mouth to obtain a transmit audio signal. The receive audio transducer is configured to convert a receive audio signal to a form perceptible by a user's ear. As one example, the head covering comprises elasticized knit textile material, and an interface circuit may be located in an occipital region of the head covering and connected to the transmit audio transducer and to the receive audio transducer.

### CROSS-REFERENCE TO RELATED APPLICATIONS

This application claims the benefit of U.S. Provisional Application No. 62/840,727, filed Apr. 30, 2019, which is incorporated in its entirety herein by reference.

### BACKGROUND

### Background of the Disclosure

The present disclosure relates generally to a garment incorporating transducers and, more particularly, textile headgear incorporating audio transducers and conforming to a user's head.

### Field of the Disclosure

Wireless communication equipment often receives and transmits audio signals. Typically, a receive audio signal received wirelessly by a handheld wireless device is provided to a user via a speaker within an enclosure of the handheld wireless device, and a transmit signal to be transmitted wirelessly by the handheld wireless device is obtained from the user via a microphone within the enclosure. Such a configuration typically necessitates a user to hold the handheld wireless device in a hand of the user to utilize the built-in speaker and microphone for two-way communication. External speaker and microphone (speaker-mic.) devices have typically been in the form of a rigid external housing that may be clipped to a user's lapel but not in the form of a wearable user interface of a textile material that conforms to a user's head. The National Aeronautics and Space Administration (NASA) developed a communications carrier assembly (CCA), colloquially referred to as a “Snoopy cap,” for astronauts to wear. While it utilizes a textile material, it has two boom microphones projecting in front of astronaut's mouth, one from the left and one from the right, which have been said to interfere with some activities, such as eating. Moreover, users of boom microphones who lack the protective bubble of a spacesuit helmet may find their boom microphones dislodged because of the awkward manner in which they project near the user's face. Accordingly, a wearable audio user interface (UI) providing technological improvement is described herein.

### BRIEF DESCRIPTION OF THE DRAWINGS

The present disclosure may be better understood, and its numerous features and advantages made apparent to those skilled in the art by referencing the accompanying drawings.

FIG. 1 is a right-side elevation view diagram of an apparatus in accordance with at least one embodiment.

FIG. 2 is a front elevation view diagram of an apparatus in accordance with at least one embodiment.

FIG. 3 is a rear elevation view diagram of an apparatus in accordance with at least one embodiment.

FIG. 4 is a left-side elevation view diagram of an apparatus in accordance with at least one embodiment.

FIG. 5 is a top plan view diagram of an apparatus in accordance with at least one embodiment.

FIG. 6 is an elevation view diagram of a transmit audio transducer in accordance with at least one embodiment.

FIG. 7 is a front elevation view diagram of a transmit audio transducer array in accordance with at least one embodiment.

FIG. 8 is a block diagram illustrating a transmit audio transducer subsystem in accordance with at least one embodiment.

FIG. 9 is a flow diagram illustrating a method in accordance with at least one embodiment.

FIG. 10 is a flow diagram illustrating a method in accordance with at least one embodiment.

The use of the same reference symbols in different drawings indicates similar or identical items.

### DETAILED DESCRIPTION OF THE DRAWINGS

An apparatus, method, and article of manufacture for providing a wearable audio user interface (UI). The wearable audio UI comprises a head covering of conformal textile material configured to cover an upper portion of a user's head. A transmit audio transducer is located in a forehead region of the head covering. The transmit audio transducer is configured to provide directional response oriented toward a user's mouth to obtain a transmit audio signal. A receive audio transducer is located in a temporal region of the head covering. The receive audio transducer is configured to convert a receive audio signal to a form perceptible by a user's ear.

As one example, the subject matter described below can be implemented as an apparatus. As another example, the subject matter described below can be produced as an article of manufacture. As yet another example, the subject matter described below can be practiced as a method. As a further example, the subject matter described below can be implemented as more than one of an apparatus, an article of manufacture, or a method.

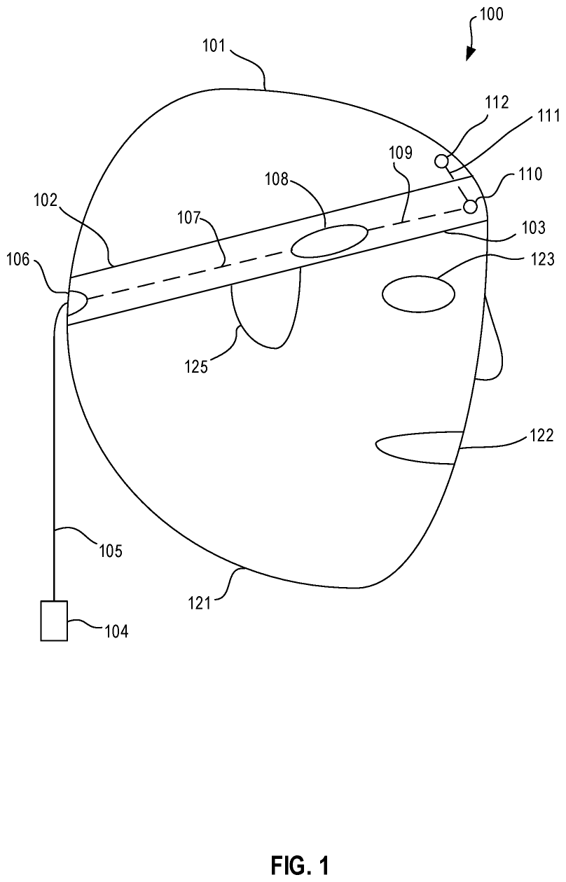

FIG. 1 is a right-side elevation view diagram of an apparatus in accordance with at least one embodiment. Apparatus 100 comprises head covering 101 with integral transducers, including receive audio transducer 108 and transmit audio transducers 110 and 112. Head covering 101 may, for example, be in the form of a skullcap. Head covering 101 may, for example, be constructed of a textile material. The textile material may, for example, be a woven textile material, a knitted textile material, a mesh textile material, or a non-woven non-directional textile material. As examples, the knitted textile material may be a jersey knit material, an interlock knit material, a double-knit material, or another knitted material. The textile material may be a polyester, polyamide, modacrylic, aramid, polyolefin, or natural fiber material. Head covering 101 comprises an elastic headband 102. An edge of elastic headband 102 forms a lower edge 103 of head covering 101. The textile of head covering 101, its headband 102, or a combination thereof, may define one or more passages in which electrical conductors, such as interconnection 107, interconnection 109, and interconnection 111, may be housed.

A bidirectional audio interface is integrated into apparatus 100. The bidirectional audio interface comprises one or more transmit audio transducers 110 and 112, one or more receive audio transducers such as receive audio transducer 108, and an interface circuit 106. As an example, connector 104 may be connected to a first end of cable 105, and a second end of cable 105 may be connected to interface circuit 106. Interface circuit 106 may be coupled to receive audio transducer 108 via interconnection 107. Interface circuit 106 may be coupled to transmit audio transducer 110 via interconnection 109 and to transmit audio transducer 112 via interconnection 111. Interconnections, such as interconnections 107, 109, and 111 may be connected directly to interface circuit 106 or, as illustrated, may provide a daisy-chained series of interconnections from one element to another to yet another. For example, interconnection 111 may be routed from transmit audio transducer 112 to transmit audio transducer 110, interconnection 109 may be routed from transmit audio transducer 110 to receive audio transducer 108, and interconnection 107 may be routed from receive audio transducer 108 to interface circuit 106.

In accordance with at least one embodiment, interface circuit 106 may be a wireless interface circuit, such as a Bluetooth transceiver, a Bluetooth low energy (BLE) transceiver, a local area network (LAN), such as wifi (e.g., Institute of Electrical and Electronics Engineers (IEEE) 802.11), transceiver, a personal area network (PAN), such as WiGig (e.g., Institute of Electrical and Electronics Engineers (IEEE) 802.11ad or 802.11y), transceiver, a wireless personal area network (PAN) transceiver, or the like. When interface circuit 106 is a wireless interface circuit, cable 105 and connector may be omitted or may supplement the wireless connectivity options of interface circuit 106 with a wired connectivity option. When cable 105 and connector 104 are provided, either with or without a wireless interface circuit, connector 104 may be a connector configured for attachment to a portable transceiver, such as a handheld two-way radio transceiver (HT), a broadband wireless transceiver, or the like, or connector 104 may be a connector configured for attachment to an intermediate connector, wherein the intermediate connector is coupled to a transceiver connector configured for attachment to a portable transceiver. Such an intermediate connector may be included within an enclosure further including a push-to-talk (PTT) switch.

In accordance with at least one embodiment, elastic headband 102 is configured to pass above or around ears, such as ear 125, of a user wearing apparatus 100. Elastic headband 102 is configured to pass above eyes, such as eye 123, of the user's head 121. In accordance with at least one embodiment, transmit audio transducers, such as transmit audio transducers 110 and 112, are configured to form a beamforming array directed toward mouth 122 of the user's head 121 to receive voice audio signals from mouth 122.

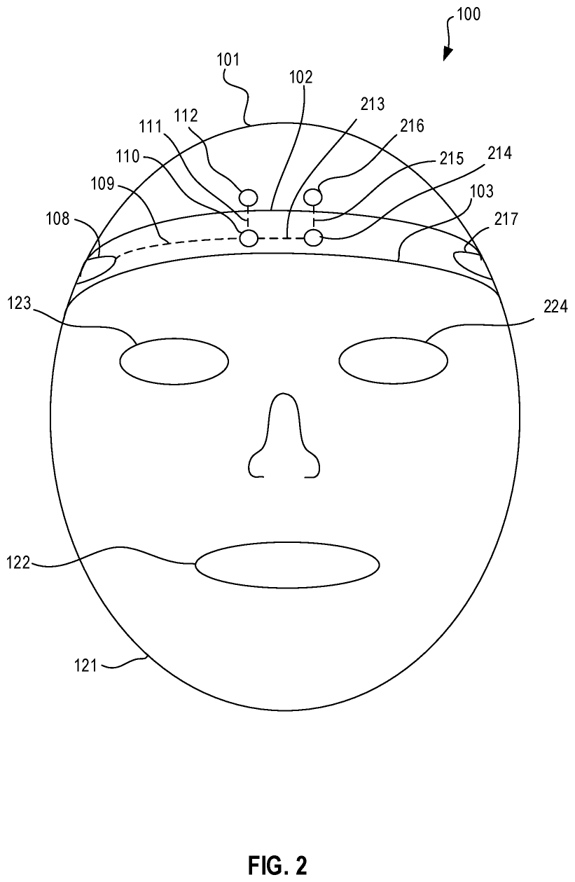

FIG. 2 is a front elevation view diagram of an apparatus in accordance with at least one embodiment. Apparatus 100 comprises head covering 101, elastic band 102, receive audio transducer 108, receive audio transducer 217, transmit audio transducer 110, transmit audio transducer 112, transmit audio transducer 214, transmit audio transducer 216, interconnection 109, interconnection 111, interconnection 213, and interconnection 215. Elastic band defines lower edge 103. At least one transmit audio transducer, such as at least one of transmit audio transducers 214 and 216, are disposed in a forehead region of head covering 101. The forehead region is configured to worn over a forehead area of a user's head, for example, over a frontal bone of the user's cranium. The location of the at least one transmit audio transducer in the forehead region of head covering 101 can improve the ability of the apparatus or article of manufacture to produce a transmit audio signal in response to a user's voice, thereby providing technological improvement.

Interconnection 109 may couple transmit audio transducer 110 to interface circuit 106 directly or, in a daisy-chained manner, via receive audio transducer 108. Interconnection 111 may couple transmit audio transducer to interface circuit 106 directly or, in a daisy-chained manner, via one or more other elements, such as transmit audio transducer 110 and receive audio transducer 108. Interconnection 213 may couple transmit audio transducer 214 to interface circuit 106 directly or, in a daisy-chained manner, via one or more other elements, such as one or more of transmit audio transducer 112, transmit audio transducer 110, and receive audio transducer 108. Interconnection 215 may couple transmit audio transducer 216 to interface circuit 106 directly or, in a daisy-chained manner, via one or more other elements, such as one or more of transmit audio transducer 214, transmit audio transducer 112, transmit audio transducer 110, and receive audio transducer 108. Alternatively, one or more interconnections for one or more of transmit audio transducers 110, 112, 214, and 216 may be routed around an opposite side of head 121, for example, either directly or via one or more other elements, such as receive audio transducer 217.

An array of transmit audio transducers, such as transmit audio transducers 110, 112, 214, and 216, are spaced apart from each other on head covering 101. One or more of the transmit audio transducers in the array may be mounted on elastic band 102. One or more of the transmit audio transducers in the array may be mounted on the portion of head covering 101 above elastic band 102. One or more of transmit audio transducers 110, 112, 214, and 216 may comprise microphones, such as conventional microphones or microelectromechanical system (MEMS) microphones. The array of transmit audio transducers can be configured as a phased array to provide audio beamforming of the directivity of the array. The directivity can be enhanced to improve sensitivity to sound coming from mouth 122 and to decrease sensitivity to sounds coming from other directions. For example, with the array positioned on the forehead of user's head 121, above the user's eyes 123 and 224, the directivity can be enhanced in a downward direction.

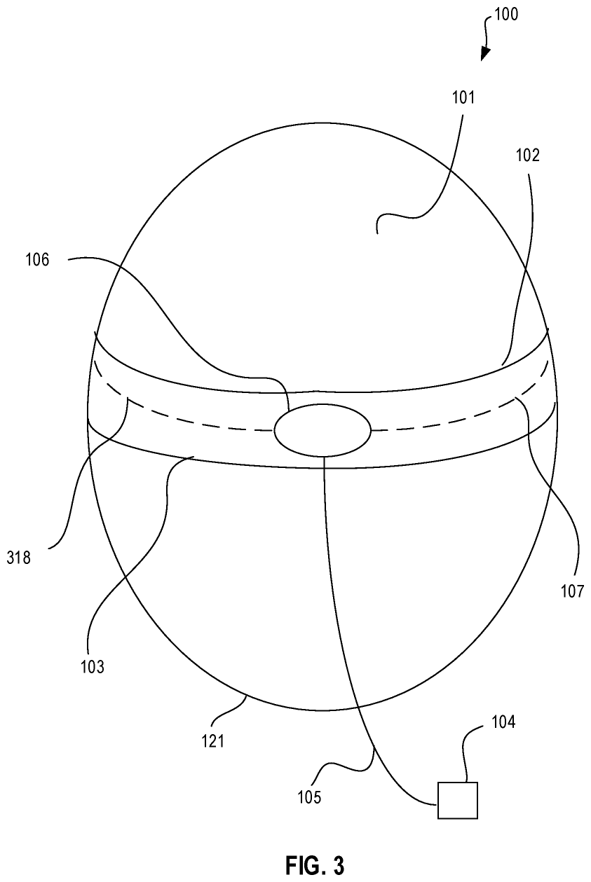

FIG. 3 is a rear elevation view diagram of an apparatus in accordance with at least one embodiment. Apparatus 100 comprises head covering 101 incorporating interconnection 107, interconnection 318, and interface circuit 106. As an example, at least one of interconnection 107, interconnection 318, and interface circuit 106 may be incorporated into elastic band 102. As shown, interface circuit 106 may be positioned at a rearmost location along head covering 101 (e.g., along elastic band 102), for example, in the center of the user's head 121. Interface circuit 106 may be connected to cable 105, which may be connected to connector 104.

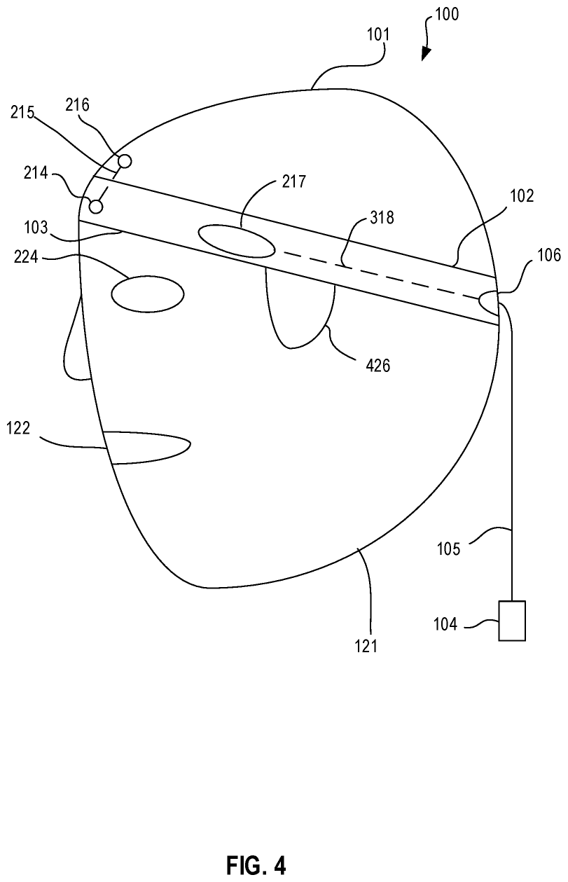

FIG. 4 is a left-side elevation view diagram of an apparatus in accordance with at least one embodiment. A left side of apparatus 100 is shown with respect to a left side of user's head 121. In accordance with at least one embodiment, elastic headband 102 is configured to pass above or around ears, such as ear 426, of a user wearing apparatus 100.

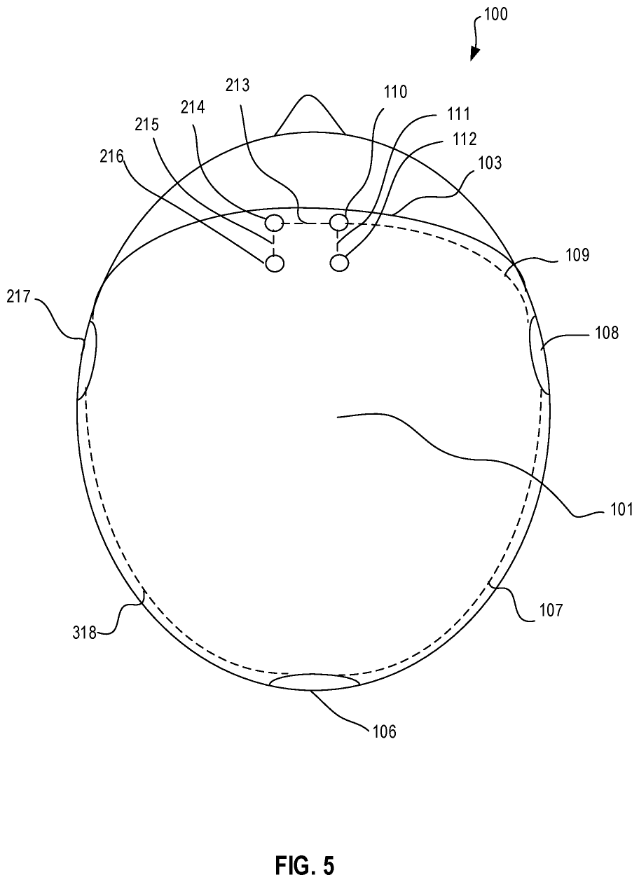

FIG. 5 is a top plan view diagram of an apparatus in accordance with at least one embodiment. Previously described elements of apparatus 100 can be seen as viewed from above a head 121 of a user wearing apparatus 100.

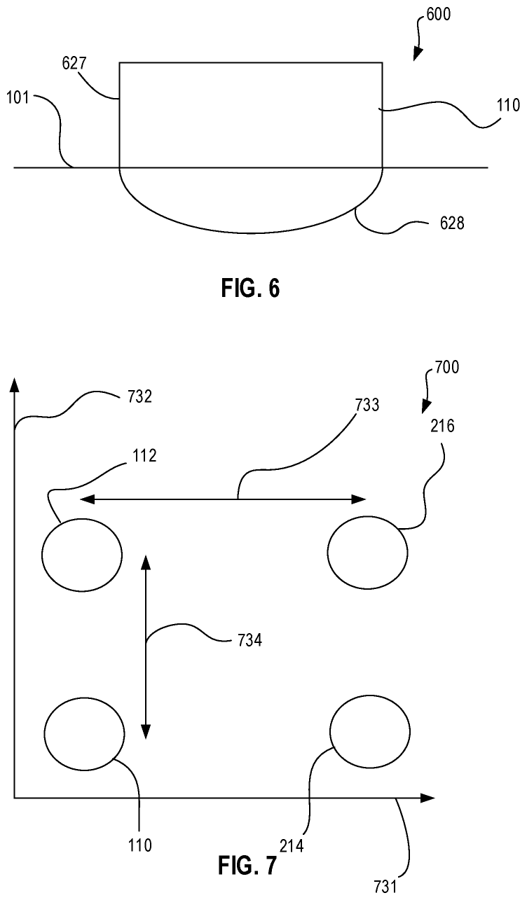

FIG. 6 is an elevation view diagram of a transmit audio transducer in accordance with at least one embodiment. In accordance with at least one embodiment, transmit audio transducer assembly, which may be used to implement transmit audio transducer 110, comprises an air-coupled microphone 627 configured to receive sound propagating via air. In accordance with at least one embodiment, transmit audio transducer 110 comprises a contact microphone 628 configured to receive sound propagating via solid material, such as a cranium and overlying skin of a user's head 121.

In the example shown in FIG. 6, a transmit audio transducer assembly 600 comprises both air-coupled microphone 627 and contact microphone 628. With both air-coupled microphone 627 and contact microphone 628, differences between the speed of sound in air and the speed of sound in a solid material, such as the head 121 of the user, can be used to distinguish a desired sound, such as the voice of the user, from undesired sound, such as ambient acoustic noise. As an example, as a user speaks, the user's voice generated by the user's vocal chords results in vibration of both air molecules and molecules of solid material of the user's body. However, the sound propagates at different speeds through air and through solid material. By measuring the shorter time sound takes to travel from a user's vocal chords to contact microphone 628 via solid material and the longer time sound takes to travel from the user's vocal chords to air-coupled microphone 627 via air through the user's mouth, a relative time delay between a contact transmit audio signal and an air-conducted transmit audio signal can be determined. The relative time delay can be used to configure enhance sensitivity of transmit audio transducer assembly 600 to sound exhibiting the relative time delay and to reduce sensitivity of transmit audio transducer assembly 600 to sound having a different relative time delay. As will be described below with respect to FIG. 7, transmit audio transducer assembly 600 may be incorporated into a transmit audio transducer array, wherein the time delay relationships between contact microphone 628 and air-coupled microphone 627 can be used in conjunction with time delay relationships between a plurality of transmit audio transducer assemblies 600 in a spatially diverse orientation to further enhance sensitivity of a transmit audio transducer subsystem to a particular sound source, such as a user's voice, and to reduce sensitivity of the transmit audio transducer subsystem to other sounds sources, such as those which are sources of ambient noise.

FIG. 7 is a front elevation view diagram of a transmit audio transducer array in accordance with at least one embodiment. Transmit audio transducer array 700 comprises transmit audio transducers 110, 112, 214, and 216 configured in the exemplary arrangement as shown on FIGS. 1-5. On FIG. 7, transmit audio transducers 110, 112, 214, and 216 are shown with respect to a horizontal axis 731 and a vertical axis 732. Transmit audio transducers 110 and 112 are arranged vertically to form a first column. Transmit audio transducers 214 and 216 are arranged vertically to form a second column. The first column is spaced a horizontal distance 733 from the second column. Transmit audio transducers 110 and 214 are arranged horizontally to form a first row. Transmit audio transducers 112 and 216 are arranged horizontally to form a second row. The first row is spaced a vertical distance 734 from the second row.

If a user's mouth 122 is located in the negative direction along vertical axis 732 (e.g., below horizontal axis 731), transmit audio transducers arranged in a row can be configured as a broadside beamforming array with respect to each other, and transmit audio transducers arranged in a column can be configured as an endfire beamforming array with respect to each other. A broadside beamforming array can be configured by summing the outputs of transmit audio transducers substantially equidistant (in terms of time delay) from a source, such as the user's mouth 122, for example, transmit audio transducers horizontally arranged in a row above a user's eyes 123 and 224. An endfire beamforming array can be configured by summing a delayed version of an output of a more proximal transmit audio transducer with an output of a more distal transmit audio transducer, wherein the output of the more distal transmit audio transducer is non-delayed or lesser-delayed than the delayed version of the output of the more proximal transmit audio transducer so as to temporally align the delayed output of the more proximal transmit audio transducer with the output of the more distal transmit audio transducer.

With respect to the example of transmit audio transducer array 700, an output of transmit audio transducer 110 can be delayed by an amount of time equal to the relative time delay for sound to pass through air between transmit audio transducer 110 and transmit audio transducer 112, and the delayed output of transmit audio transducer 110 can be summed with the output of transmit audio transducer 112 to provide an endfire array output signal. As another example, the outputs of transmit audio transducers 110 and 214 can be summed with zero relative time delay to provide a broadside array output signal. One or more endfire array output signals can be combined one or more other endfire array output signals or one or more broadside array output signals. One or more broadside array output signals can be combined with one or more other broadside array output signals or one or more endfire array output signals. The use of multiple arrays of the same type, different types, or combinations thereof, combined together, can improve the sensitivity and selectivity of transmit audio transducer array 700.

By accounting for a plurality of angular relationships of transmit audio transducers of the array, the directivity of the array can be not only unidirectional, but can also be multidirectional, include one or more additional directional components at one or more angles to a first direction. For example, multidirectional directivity configured to converge at a point or within an area defined not only angularly from the array but also in terms of distance from the array. As an example, orienting multidirectional directivity to provide parallax can improve sensitivity and selectivity at a particular distance from the array in the first direction. As another example, an additive contribution of one or more arrays can be combined with a subtractive contribution of one or more other arrays (which may or may not share at least one common transmit audio transducer), which can improve sensitivity and selectivity of the overall array. For example, in the example shown in FIG. 7, an additive contribution of an endfire array comprising transmit audio transducer 110 and transmit audio transducer 112 can be combined with a subtractive contribution of an endfire array comprising transmit audio transducer 110 and transmit audio transducer 216 to subtract the influence of any ambient noise that may be present diagonally to the left, as shown on FIG. 7, from a positive result obtained from a desired sound source located in a downward direction from the transmit audio transducer array 700 of FIG. 7. The number and spacing of transmit audio transducers in transmit audio transducer array 700 may be varied to provide greater or lesser granularity in angular specificity of the response to transmit audio transducer array 700.

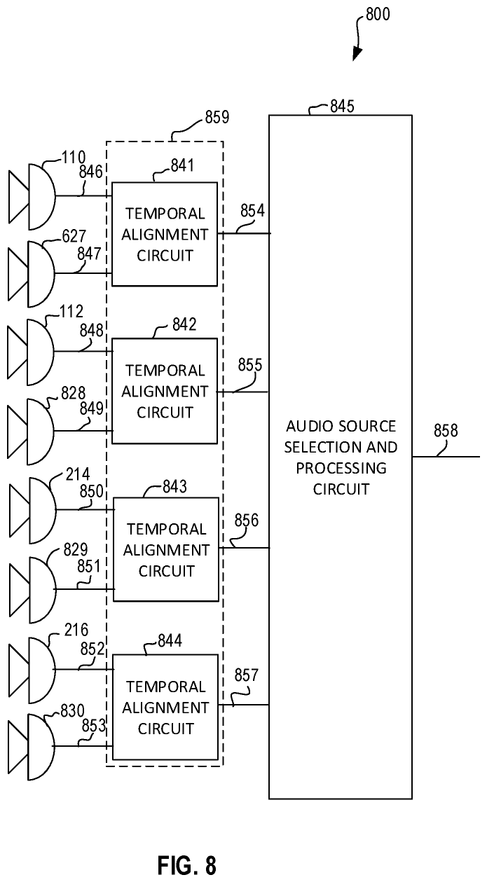

FIG. 8 is a block diagram illustrating a transmit audio transducer subsystem in accordance with at least one embodiment. Transmit audio transducer subsystem 800 comprises transmit audio transducers 110, 627, 112, 828, 214, 829, 216, and 830, a temporal alignment subsystem 859 comprising temporal alignment circuits 841, 842, 843, and 844, and an audio source selection and processing circuit 845. Transmit audio transducer 110 is connected to a first input of temporal alignment circuit 841 via interconnection 846. Transmit audio transducer 627 is connected to a second input of temporal alignment circuit 841 via interconnection 847. Transmit audio transducer 112 is connected to a first input of temporal alignment circuit 842 via interconnection 848. Transmit audio transducer 828 is connected to a second input of temporal alignment circuit 842 via interconnection 849. Transmit audio transducer 214 is connected to a first input of temporal alignment circuit 843 via interconnection 850. Transmit audio transducer 829 is connected to a second input of temporal alignment circuit 843 via interconnection 851. Transmit audio transducer 216 is connected to a first input of temporal alignment circuit 844 via interconnection 852. Transmit audio transducer 830 is connected to a second input of temporal alignment circuit 844 via interconnection 853.

An output of temporal alignment circuit 841 is connected to a first input of audio source selection and processing circuit 845 via interconnection 854. An output of temporal alignment circuit 842 is connected to a second input of audio source selection and processing circuit 845 via interconnection 855. An output of temporal alignment circuit 843 is connected to a third input of audio source selection and processing circuit 845. An output of temporal alignment circuit 844 is connected to a fourth input of audio source selection and processing circuit 845. An output of audio source selection and processing circuit is provided at interconnection 858.

As an example, transmit audio transducer subsystem 800 can be configured such that transmit audio transducer 110 is an air-coupled microphone and transmit audio transducer 627 is its corresponding co-located contact microphone, for example, as shown in FIG. 6; transmit audio transducer 112 is an air-coupled microphone and transmit audio transducer 828 is its corresponding co-located contact microphone; transmit audio transducer 214 is an air-coupled microphone and transmit audio transducer 829 is its corresponding co-located contact microphone; and transmit audio transducer 216 is an air-coupled microphone and transmit audio transducer 830 is its corresponding co-located contact microphone. Temporal alignment circuit 841 can introduce a delay in either or both of the signals received at its two inputs. For example, temporal alignment circuit 841 can introduce a delay in the signal received at its second input over interconnection 847 from transmit audio transducer 627 to temporally align that signal with the signal received at its first input over interconnection 846 from transmit audio transducer 110. When adjusted for a relative time delay characteristic of sounds from a user's voice, wherein the air-coupled signal is delayed relative to the contact signal, temporal alignment circuit 841 can provide selectivity for the user's voice against a background of other sounds, such as ambient noise. Temporal alignment circuit 841 can also be used to identify unwanted noise, such as an object rubbing against or striking transmit audio transducer assembly 600 or other parts of apparatus 100, as the signals from an air-coupled microphone and a contact microphone corresponding to such noise are contemporaneous and do not exhibit the relative time delay characteristic of signals obtained from a user's voice. Such unwanted noise can be effectively ignored by removing it from the signal, for example, by subtractive combination. The features and operations described with respect to temporal alignment circuit 841 and the transmit audio transducers from which it receives signals can be similarly applied to temporal alignment circuits 842, 843, and 844, and their respective transmit audio transducers.

In accordance with at least one embodiment, transmit audio transducer subsystem 800 can selectively obtain a transmit audio signal from one or more air-coupled microphones and one or more contact microphones in response to voice content obtained, respectively, from the one or more air-coupled microphones and the one or more contact microphones. For example, temporally aligned versions of an air-coupled microphone signal and a contact microphone signal can be provided by a temporal alignment circuit to audio source selection and processing circuit 845. Audio source selection and processing circuit 845 can implement a voice activity detector (VAD), such as a deep-learning-based voice activity detector, which may implement a neural network, such as a recurrent neural network (RNN). The VAD can comparatively evaluate the air-coupled microphone signal and the contact microphone signal and select between the air-coupled microphone signal, the contact microphone signal, and a combination of the air-coupled microphone signal and the contact microphone signal to obtain a transmit audio signal to provide at interconnection 858.

As an example, in an environment where an air-coupled microphone signal has a lower signal-to-noise ratio (SNR), as may be determined, for example, by a VAD, than the SNR of a contact microphone signal, which may also be determined, for example, by a VAD, the contact microphone signal may be selected to obtain a transmit audio signal or a combination of the contact microphone signal and the air-coupled microphone signal that is weighted in favor of the contact microphone signal may be selected to obtain a transmit audio signal. As another example, in an environment where an air-coupled microphone signal has a higher SNR than the SNR of a contact microphone signal, the air-coupled microphone signal may be selected to obtain a transmit audio signal or a combination of the air-coupled microphone signal and the contact microphone signal that is weighted in favor of the air-coupled microphone signal may be selected to obtain a transmit audio signal. An example of a situation where the air-coupled microphone signal may have a lower SNR than the SNR of a contact microphone signal is in the presence of high wind noise or other high ambient noise, where such noise may arise, in the case of wind noise, from interaction with the air or, in the case of other high ambient noise, from conduction through the air of noise generated by some acoustic noise source. An example of a situation where the air-coupled microphone signal may have a higher SNR than the SNR of a contact microphone is in the presence of anatomical movement of a user or movement of clothing or accessories of a user, the noise from which may be conducted through the body of the user to the contact microphone, while the air-coupled microphone would be relatively free of such noise.

In accordance with at least one embodiment, a method and apparatus for clarification of the transmit audio signal is provided. Such a method and apparatus may be useful, for example, when a user is to wear headgear, such as a helmet, that may alter the sound being received by at least one air-coupled microphone or at least one contact microphone. Such alteration can be counteracted by having the user first wear head covering 101 without the headgear, such as a helmet, to allow apparatus 100 to obtain samples of transmit audio in absence the headgear that may alter the sound. Audio source selection and processing circuit 845 characterizes such samples to obtain an unaltered sound characterization. The user can then don the headgear that may alter the sound to allow apparatus 100 to obtain samples of transmit audio in the presence of the headgear that may alter the sound. Audio source selection and processing circuit 845 characterizes such samples to obtain an altered sound characterization. The audio source selection and processing circuit 845 can compare the altered sound characterization to the unaltered sound characterization to determine characteristics of the alteration occurring. For example, audio source selection and processing circuit 845 may perform a Fourier transform of the sampled transmit audio and search for differences in the frequency domain, such as those that would indicate one or more resonances of the headgear at one or more respective frequencies. Audio source selection and processing circuit 845 can then perform spectral equalization to flatten the response of apparatus 100 and deemphasize any resonances resulting from the wearing of the headgear. As another example, audio selection and processing circuit 845 may perform correlation in the time domain over a range of time delay durations to identify any echoes from reflections, such as a reflection of the user's voice from the underside of a visor of a helmet worn by the user. As the indirect path of the reflected acoustic signal will be longer than the direct path of a direct acoustic signal from the user's mouth to the transmit audio transducers, the reflected acoustic signal will be delayed relative to the direct acoustic signal. The presence of the same signal delayed in time can be identified by performing correlation over the range of possible time delay durations. Then, audio selection and processing circuit 845 can perform echo cancellation on the reflected acoustic signal to obtain the direct acoustic signal. Audio selection and processing circuit 845 can validate the echo cancellation by referencing the unaltered sound characterization obtained when the headgear altering the sound was not worn to provide assurance that the result of the echo cancellation is satisfactorily similar. Otherwise, audio selection and processing circuit 845 can use the unaltered sound characterization to further tune the performance of the echo cancellation.

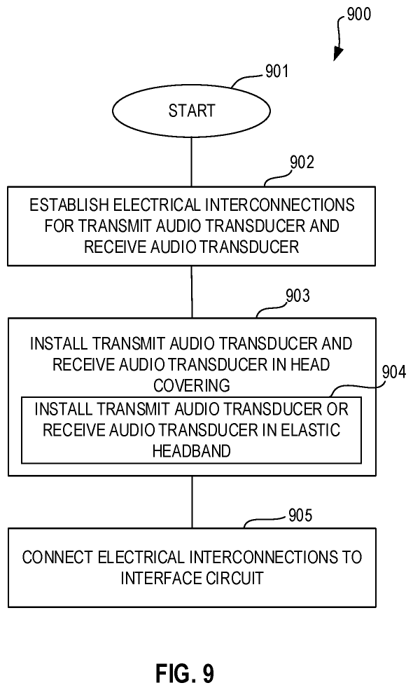

FIG. 9 is a flow diagram illustrating a method in accordance with at least one embodiment. Method 900 begins in block 901 and continues to block 902. At block 902, electrical connections are established for at least one transmit audio transducer and for at least one receive audio transducer. From block 902, method 900 continues to block 903. At block 903, the at least one audio transducer and the at least one receive audio transducer are installed in a head covering. Block 902 may comprise block 903. At block 903, at least one of the at least one transmit audio transducer and the receive audio transducer is installed in an elastic headband of the head covering. From block 902, method 900 continues to block 904. At block 904, the electrical interconnections are connected to an interface circuit.

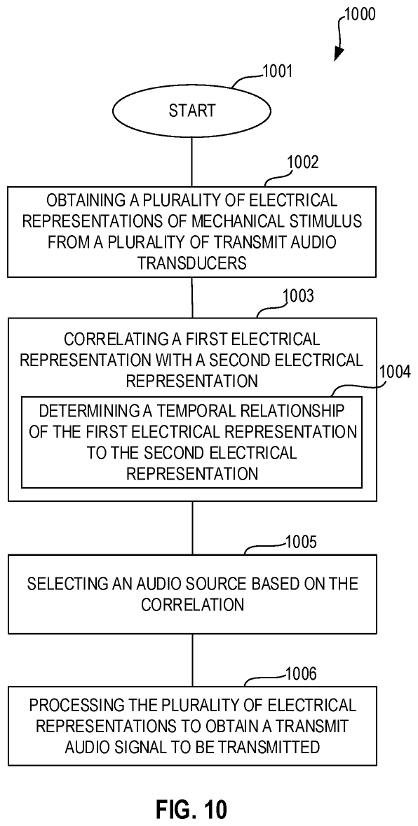

FIG. 10 is a flow diagram illustrating a method in accordance with at least one embodiment. Method 1000 begins in block 1001 and continues to block 1002. At block 1002, a plurality of electrical representations of mechanical stimulus are obtained from a plurality of transmit audio transducers. From block 1002, method 1000 continues to block 1003. At block 1003, a first electrical representation is correlated with a second electrical representation. Block 1003 may comprise block 1004. At block 1004, a temporal relationship of the first electrical representation to the second electrical representation is determined. From block 1003, method 1000 continues to block 1005. At block 1005, an audio source is selected based on the correlation. From block 1005, method 1000 continues to block 1006. At block 1006, the plurality of electrical representations are processed to obtain a transmit audio signal to be transmitted.

Referring back to FIGS. 1-6, at least one embodiment may be implemented using a contact microphone, such as contact microphone 628 configured to be situated over the occipital bone or the lower parietal bone of the cranium, for example, where interface circuit 106 is shown as being located. Such a contact microphone can receive bone-conducted sound resultant from vibration of a user's vocal chords. Such a contact microphone can be used in conjunction with a receive audio transducer, such as a receive audio transducer similar to receive audio transducer 108 or receive audio transducer 217. One or more receive audio transducers may be configured as receive audio transducer 108 or receive audio transducer 217 to be near temporal bone portions of a user's cranium on one or both sides of a user's head. One or more receive audio transducers may be air-conducting transducers, such as earphones. One or more receive audio transducers may be bone-conducting transducers, which may impart vibration to a bone, such as a temporal bone of the cranium by bearing against the bone through skin and, if any, overlying fabric. An aperture may be defined in head covering 101, elastic headband 102, or both to provide access to and contact with a user's head for a receive audio transducer. A receive audio transducer may be configured to be situated over the occipital bone or the lower parietal bone of the cranium, for example, where interface circuit 106 is shown as being located. Such a receive audio transducer may provide sound via bone conduction to a user's ears.

In accordance with at least one embodiment, elements described above can be configured to attach to a pre-existing structure, such as eyeglasses, goggles, a helmet, a hat, a cap, or another article worn on a head of a user. For example, receive audio transducers 108 and 217 may be provided with clips to clip onto temples of eyeglasses, transmit audio transducers 110, 112, 214, and 216 may be provided with clips, either singularly or collectively, to clip onto a nose bridge of the eyeglasses. As an example, interface circuit 106 may be provided with a clip to clip it to a convenient anchor point, such as a shirt or jacket collar of a shirt or jacket worn by the user. As another example, clips as described above may be provided and utilized to attach elements, such as transmit audio transducers 110, 112, 214, and 216, receive audio transducers 108 and 217, and interface circuit 106, to a helmet worn by the user, for example, by attachment to a headband of the helmet. In accordance with at least one embodiment, the elements described above can be incorporated into a structure, such as eyeglasses, goggles, a helmet, a hat, a cap, or another article worn on a head of a user, and the structure with the incorporated elements can be manufactured in a unitized manner.

In accordance with at least one embodiment, interface circuit 106 may provide a wired interface or a wireless interface. Examples of a wired interface include an interface to a connector for a wireless communications device, such as a two-way radio or a telephone, and an interface to an accessory device which connects to a wireless radio device, such as a two-way radio or a telephone. Examples of an accessory device include a push-to-talk (PTT) interface device and an interoperability device capable of connecting together multiple wireless communication devices. Examples of a wireless interface include a Bluetooth interface, a magnetic induction interface, and an infrared communication interface.

In accordance with at least one embodiment, components of apparatus 100, such as receive audio transducers 108 and 217 and transmit audio transducers 110, 112, 214, and 216 may be sewn into portions of head covering 101, such as portions of elastic headband 102. Interconnections such as interconnections 107, 109, 111, 213, 215, and 318 can be sewn into channels defined in layers of fabric, such as in layers of head covering 101, which may include elastic headband 102. As an example, at least one of receive audio transducers 108 and 217 or at least one of transmit audio transducers 110, 112, 214, and 216 may be bonded to a respective portion of head covering 101, for example, by snapping two portions together from opposite sides of the fabric of head covering 101, by using an adhesive to secure the element to the respective portion of head covering 101, by thermally fusing the element to the respective portion of head covering 101, by ultrasonically welding the element to the respective portion of head covering 101, or the like.

In accordance with at least one embodiment, an apparatus comprises a head covering configured to cover an upper portion of a user's head; a transmit audio transducer located in a forehead region of the head covering, the transmit audio transducer configured to provide directional response oriented toward a user's mouth to obtain a transmit audio signal; and a receive audio transducer located in a temporal region of the head covering, the receive audio transducer configured to convert a receive audio signal to a form perceptible by a user's ear. In accordance with at least one embodiment, the head covering is a skullcap of elasticized knit textile material. In accordance with at least one embodiment, the receive audio transducer comprises a contact surface exposed to enable direct contact with the user's head through an aperture defined on an interior surface of the head covering. In accordance with at least one embodiment, the apparatus further comprises a transmit audio transducer array comprising the transmit audio transducer and at least one other transmit audio transducer, the transmit audio transducer array configured to provide the directional response oriented toward the user's mouth. In accordance with at least one embodiment, the transmit audio transducer array comprises a transmit audio transducer assembly, the transmit audio transducer assembly comprising the transmit audio transducer and the at least one other transmit audio transducer, the transmit audio transducer being an air-coupled microphone, and the at least one other transmit audio transducer being a contact microphone. In accordance with at least one embodiment, the apparatus further comprises an audio selection and processing circuit, the audio selection and processing circuit comprising a voice activity detector, the voice activity detector configured to provide a first indication of voice activity from an air-coupled microphone signal of the air-coupled microphone and a second indication of voice activity from a contact microphone signal of the contact microphone, the voice activity detector configured to cause the audio selection and processing circuit to selectively extract a voice signal from a group consisting of the air-coupled microphone signal, the contact microphone signal, and a combination of the air-coupled microphone signal and the contact microphone signal. In accordance with at least one embodiment, the apparatus further comprises an interface circuit, the interface circuit located in an occipital region of the head covering, the interface circuit connected to the transmit audio transducer and to the receive audio transducer.

In accordance with at least one embodiment, a method comprises establishing electrical interconnections for a transmit audio transducer and a receive audio transducer; installing the transmit audio transducer and the receive audio transducer in a head covering, wherein the transmit audio transducer is configured to be situated over a bone of a user's cranium selected from a group consisting of a frontal bone, a parietal bone, and an occipital bone; and connecting the electrical connections to an interface circuit. In accordance with at least one embodiment, the installing the transmit audio transducer and the receive audio transceiver in the head covering comprises installing at least one of the transmit audio transducer and the receive audio transducer in an elastic headband of the head covering. In accordance with at least one embodiment, the installing the transmit audio transducer and the receive audio transceiver in the head covering comprises installing at least one of the transmit audio transducer and the receive audio transducer at an aperture defined in the head covering. In accordance with at least one embodiment, the transmit audio transducer comprises a contact microphone configured for converting mechanical vibration of the user's cranium into an electrical signal. In accordance with at least one embodiment, the receive audio transducer is configured to be situated over a temporal bone of the user's cranium. In accordance with at least one embodiment, the interface circuit is configured to be situated over the occipital bone of the user's cranium. In accordance with at least one embodiment, the transmit audio transducer comprises an air-coupled microphone and a contact microphone, wherein the installing the transmit audio transducer and the receive audio transducer in a head covering comprises installing the air-coupled microphone to be exposed on an outside surface of the head covering; and installing the contact microphone to be exposed on an inside surface of the head covering.

In accordance with at least one embodiment, an article of manufacture comprises a head covering configured to cover an upper portion of a user's head; a transmit audio transducer integrated into a forehead region of the head covering, the transmit audio transducer configured to obtain a transmit audio signal based on a user's voice; and a receive audio transducer integrated into a temporal region of the head covering, the receive audio transducer configured to convert a receive audio signal to a form perceptible by a user's ear. In accordance with at least one embodiment, the head covering is a skullcap of elasticized knit textile material. In accordance with at least one embodiment, the receive audio transducer comprises a contact surface exposed to enable direct contact with the user's head through an aperture defined on an interior surface of the head covering. In accordance with at least one embodiment, the article of manufacture further comprises a transmit audio transducer array comprising the transmit audio transducer and at least one other transmit audio transducer, the transmit audio transducer array configured to provide the directional response oriented toward the user's mouth. In accordance with at least one embodiment, the transmit audio transducer further comprises a transmit audio transducer assembly, the transmit audio transducer assembly comprising the transmit audio transducer and the at least one other transmit audio transducer, the transmit audio transducer being an air-coupled microphone, and the at least one other transmit audio transducer being a contact microphone. In accordance with at least one embodiment, the article of manufacture further comprises an audio selection and processing circuit, the audio selection and processing circuit comprising a voice activity detector, the voice activity detector configured to provide a first indication of voice activity from an air-coupled microphone signal of the air-coupled microphone and a second indication of voice activity from a contact microphone signal of the contact microphone, the voice activity detector configured to cause the audio selection and processing circuit to selectively extract a voice signal from a group consisting of the air-coupled microphone signal, the contact microphone signal, and a combination of the air-coupled microphone signal and the contact microphone signal.

The concepts of the present disclosure have been described above with reference to specific embodiments. However, one of ordinary skill in the art will appreciate that various modifications and changes can be made without departing from the scope of the present disclosure as set forth in the claims below. In particular, the numbers, types, and locations of transducers may be varied with respect to a user's anatomy by positioning such transducers at various locations with respect to head covering 101 or elastic headband 102. Accordingly, the specification and figures are to be regarded in an illustrative rather than a restrictive sense, and all such modifications are intended to be included within the scope of the present disclosure.

Those skilled in the art will recognize that the boundaries between structural blocks, such as processing blocks and logic blocks, are merely illustrative and that alternative embodiments may merge structural blocks or circuit elements or impose an alternate decomposition of functionality upon various structural blocks or circuit elements. Thus, it is to be understood that the architectures depicted herein are merely exemplary, and that in fact many other architectures can be implemented which achieve the same functionality. For example, one or more structural blocks may be implemented as one or more circuits, and one or more circuits may be implemented as a structural block.

Also, for example, in one embodiment, the illustrated examples may be implemented as circuitry located on a single integrated circuit or within a same device. For example, temporal alignment subsystem 859 and audio source selection and processing circuit 845 may be located on a single integrated circuit. Alternatively, the examples may be implemented as any number of separate integrated circuits or separate devices interconnected with each other in a suitable manner. For example, one or more of temporal alignment circuits 841, 842, 843, and 844 may be located on a separate device. Also, for example, the examples, or portions thereof, may implemented as soft or code representations of physical circuitry or of logical representations convertible into physical circuitry, such as in a hardware description language of any appropriate type.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. An apparatus comprising:
a head covering configured to cover an upper portion of a user's head;
a transmit audio transducer located in a forehead region of the head covering, the transmit audio transducer configured to provide directional response oriented toward a user's mouth to obtain a transmit audio signal; and
a receive audio transducer located in a temporal region of the head covering, the receive audio transducer configured to convert a receive audio signal to a form perceptible by a user's ear.

2. The apparatus of claim 1 wherein the head covering is a skullcap of elasticized knit textile material.

3. The apparatus of claim 1 wherein the receive audio transducer comprises a contact surface exposed to enable direct contact with the user's head through an aperture defined on an interior surface of the head covering.

4. The apparatus of claim 1 further comprising:
a transmit audio transducer array comprising the transmit audio transducer and at least one other transmit audio transducer, the transmit audio transducer array configured to provide the directional response oriented toward the user's mouth.

5. The apparatus of claim 1 wherein the transmit audio transducer array comprises:
a transmit audio transducer assembly, the transmit audio transducer assembly comprising the transmit audio transducer and the at least one other transmit audio transducer, the transmit audio transducer being an air-coupled microphone, and the at least one other transmit audio transducer being a contact microphone.

6. The apparatus of claim 1 further comprising:
an audio selection and processing circuit, the audio selection and processing circuit comprising:
a voice activity detector, the voice activity detector configured to provide a first indication of voice activity from an air-coupled microphone signal of the air-coupled microphone and a second indication of voice activity from a contact microphone signal of the contact microphone, the voice activity detector configured to cause the audio selection and processing circuit to selectively extract a voice signal from a group consisting of the air-coupled microphone signal, the contact microphone signal, and a combination of the air-coupled microphone signal and the contact microphone signal.

7. The apparatus of claim 1 further comprising:
an interface circuit, the interface circuit located in an occipital region of the head covering, the interface circuit connected to the transmit audio transducer and to the receive audio transducer.

8. A method comprising:
establishing electrical interconnections for a transmit audio transducer and a receive audio transducer;
installing the transmit audio transducer and the receive audio transducer in a head covering, wherein the transmit audio transducer is configured to be situated over a bone of a user's cranium selected from a group consisting of a frontal bone, a parietal bone, and an occipital bone; and
connecting the electrical connections to an interface circuit.

9. The method of claim 8 wherein the installing the transmit audio transducer and the receive audio transceiver in the head covering comprises:
installing at least one of the transmit audio transducer and the receive audio transducer in an elastic headband of the head covering.

10. The method of claim 8 wherein the installing the transmit audio transducer and the receive audio transceiver in the head covering comprises:
installing at least one of the transmit audio transducer and the receive audio transducer at an aperture defined in the head covering.

11. The method of claim 8 wherein the transmit audio transducer comprises a contact microphone configured for converting mechanical vibration of the user's cranium into an electrical signal.

12. The method of claim 8 wherein the receive audio transducer is configured to be situated over a temporal bone of the user's cranium.

13. The method of claim 8 wherein the interface circuit is configured to be situated over the occipital bone of the user's cranium.

14. The method of claim 8 wherein the transmit audio transducer comprises an air-coupled microphone and a contact microphone, wherein the installing the transmit audio transducer and the receive audio transducer in a head covering comprises:
installing the air-coupled microphone to be exposed on an outside surface of the head covering; and
installing the contact microphone to be exposed on an inside surface of the head covering.

15. An article of manufacture comprising:
a head covering configured to cover an upper portion of a user's head;
a transmit audio transducer integrated into a forehead region of the head covering, the transmit audio transducer configured to obtain a transmit audio signal based on a user's voice; and
a receive audio transducer integrated into a temporal region of the head covering, the receive audio transducer configured to convert a receive audio signal to a form perceptible by a user's ear.

16. The article of manufacture of claim 15 wherein the head covering is a skullcap of elasticized knit textile material.

17. The article of manufacture of claim 15 wherein the receive audio transducer comprises a contact surface exposed to enable direct contact with the user's head through an aperture defined on an interior surface of the head covering.

18. The article of manufacture of claim 15 further comprising:
a transmit audio transducer array comprising the transmit audio transducer and at least one other transmit audio transducer, the transmit audio transducer array configured to provide the directional response oriented toward the user's mouth.

19. The article of manufacture of claim 18 wherein the transmit audio transducer further comprises:
a transmit audio transducer assembly, the transmit audio transducer assembly comprising the transmit audio transducer and the at least one other transmit audio transducer, the transmit audio transducer being an air-coupled microphone, and the at least one other transmit audio transducer being a contact microphone.

20. The article of manufacture of claim 15 further comprising:
an audio selection and processing circuit, the audio selection and processing circuit comprising:
a voice activity detector, the voice activity detector configured to provide a first indication of voice activity from an air-coupled microphone signal of the air-coupled microphone and a second indication of voice activity from a contact microphone signal of the contact microphone, the voice activity detector configured to cause the audio selection and processing circuit to selectively extract a voice signal from a group consisting of the air-coupled microphone signal, the contact microphone signal, and a combination of the air-coupled microphone signal and the contact microphone signal.
